(19) United States
(12) Patent Application Publication
(10) Pub. No.: US 2026/0044042 A1
(43) Pub. Date: Feb. 12, 2026

(54) DISPLAY PANEL

(71) Applicant: ( GUANGZHOU CHINA STAR OPTOELECTRONICS SEMICONDUCTOR DISPLAY TECHNOLOGY CO.,LTD.), Guangzhou (CN)

(72) Inventor: Paijie CHEN, Guangzhou (CN)

(21) Appl. No.: 18/013,044

(22) PCT Filed: Aug. 29, 2022
(86) PCT No.: PCT/CN2022/115495

§ 371 Date: Jun. 11, 2025

(30) Foreign Application Priority Data
Jul. 28, 2022 (CN) 202210899319.7

(51) Int. Cl. G02F 1/1339; G02F 1/1333; G02F 1/1335

(52) U.S. Cl. CPC G02F 1/1339; G02F 1/133311; G02F 1/133514

(57) ABSTRACT

A display panel is disclosed in an embodiment of this invention, which includes a display area and a non-display area surrounding the display area, an array substrate and a color film substrate arranged opposite to each other and both extending from the display area to the non-display area, a liquid crystal layer arranged between the array substrate and the color film substrate and extending from the display area to the non-display area, a sealant surrounding the liquid crystal layer and arranged in the non-display area, and a retaining wall arranged in the liquid crystal layer in the non-display area.

### BACKGROUND OF DISCLOSURE

### Technical Field

The present invention relates to a technical field of display panels, and specifically, to a display panel.

### Description of Prior Art

With progress of science and technology, liquid crystal displays (LCDs) are more and more widely used. There are in-plane switching (IPS), fringe field switching (FFS), multi-domain vertical alignment (VA), and other modes; and requirements are higher and higher. For example, narrow frame requirements are the requirements for frame widths to be smaller and smaller, and consequently, sealing property of a sealant is weakened, reducing an insulation effect of the sealant on outside water vapor.

For gate on array (GOA) products, the outside water vapor can easily enter a cell through a corner of a liquid crystal cell, leading to corrosion of GOA devices and affecting product performance. In particular, when the liquid crystal cell is peeling at the corner caused by an external force, the GOA devices near the corner are easily corroded, resulting in abnormal display.

In view of this, it is necessary to develop a new type of display panel to solve a problem that the GOA devices near the corner of a display panel in the prior art are prone to corrosion.

### BRIEF SUMMARY OF DISCLOSURE

### Technical Problems

A display panel is provided in embodiments of the present invention, which is used to solve a problem that GOA devices near a corner of a display panel in the prior art are prone to corrosion.

### Technical Solutions of the Problems

### Technical Solutions

In order to solve the above-mentioned technical problem, the embodiments of the present invention disclose following technical solutions:

A display panel is provided, which has a display area and a non-display area surrounding the display area, and comprises: an array substrate and a color film substrate arranged opposite to each other and both extending from the display area to the non-display area; a liquid crystal layer arranged between the array substrate and the color film substrate and extending from the display area to the non-display area; a sealant arranged between the array substrate and the color film substrate and surrounding the liquid crystal layer, and the sealant located in the non-display area; and a retaining wall arranged in the liquid crystal layer in the non-display area.

In addition to one or more features disclosed above, or alternatively, a bottom portion of the retaining wall abuts the array substrate, and a gap is provided between a top portion of the retaining wall and the color film substrate.

In addition to one or more features disclosed above, or alternatively, a top portion of the retaining wall abuts the color film substrate, and a gap is provided between a bottom portion of the retaining wall and the array substrate.

In addition to one or more features disclosed above, or alternatively, the retaining wall comprises a first retaining wall and a second retaining wall, a bottom portion of the first retaining wall abuts the array substrate, and a gap is provided between a top portion of the first retaining wall and the color film substrate; a top portion of the second retaining wall abuts the color film substrate, and a gap is provided between a bottom portion of the second retaining wall and the array substrate; and the first retaining wall and the second retaining wall are staggered.

In addition to one or more features disclosed above, or alternatively, a bottom portion of the retaining wall abuts the array substrate, and a top portion of the retaining wall abuts the color film substrate.

In addition to one or more features disclosed above, or alternatively, a width of the sealant ranges from 0.3 um to 1.5 um.

In addition to one or more features disclosed above, or alternatively, an axial cross-sectional shape of the retaining wall is triangular, trapezoidal, rectangular, or inverted trapezoidal.

In addition to one or more features disclosed above, or alternatively, a material of the retaining wall is photosensitive resin.

In addition to one or more features disclosed above, or alternatively, a material of the retaining wall is acrylic copolymer.

Because the retaining wall is organic and liquid crystals are organic, there will be a molecular force between them. Existence of the retaining wall will hinder flow of the liquid crystals. When the liquid crystals are difficult to flow, water vapor from outside is also difficult to flow. The water vapor from the outside is blocked by the retaining wall, and it is not easily to flow, which prolongs time to reach a GOA device, thus prolonging corrosion time of the GOA and prolonging service life of the panel.

In addition to one or more features disclosed above, or alternatively, a number of the retaining walls is 2 or more, and a distance between the retaining walls ranges from 20 um to 100 um.

In addition to one or more features disclosed above, or alternatively, a height of the retaining wall ranges from 1 um to 10 um, and a diameter of a bottom portion of the retaining wall ranges from 5 um to 50 um.

In addition to one or more features disclosed above, or alternatively, the sealant seals the array substrate and the color film substrate.

In addition to one or more features disclosed above, or alternatively, the retaining wall is arranged at four corners of the liquid crystal layer, and at each of the corners, a distribution area of the retaining wall is L-shaped; the distribution area comprises a transverse area and a longitudinal area extending perpendicular to each other, and each of the transverse area and the longitudinal area has a plurality of the retaining walls arranged in an array.

In addition to one or more features disclosed above, or alternatively, the retaining wall is arranged at four corners of the liquid crystal layer, at each of the corners, a distribution area of the retaining wall comprises a first area located at the corner, and a second area and a third area connected with adjacent two sides of the first area, respectively; a shape of the first area is a square, and shapes of the second area and the third area are both trapezoidal or triangular.

### Beneficial Effects

### Beneficial Effects

One of the above-mentioned technical solutions has following advantages or beneficial effects: the retaining wall is set in the liquid crystal layer surrounded by the sealant on the non-display area, because the retaining wall is organic and liquid crystals are organic, there will be a molecular force between them. Existence of the retaining wall will hinder flow of the liquid crystals. When the liquid crystals are difficult to flow, water vapor entered from an outside is also difficult to flow. The water vapor entered from the outside is blocked by the retaining wall, and it does not easily flow, which prolongs time to reach a GOA device, thus prolonging corrosion time of GOA and prolonging service life of the panel.

### BRIEF DESCRIPTION OF DRAWINGS

### Description of Drawings

Technical schemes and other beneficial effects of the present invention will be apparent by detailed description of the specific embodiments of the present invention in combination with accompanying drawings.

FIG. 1 is a schematic top-view structural diagram of a display panel provided in a first embodiment of the present invention.

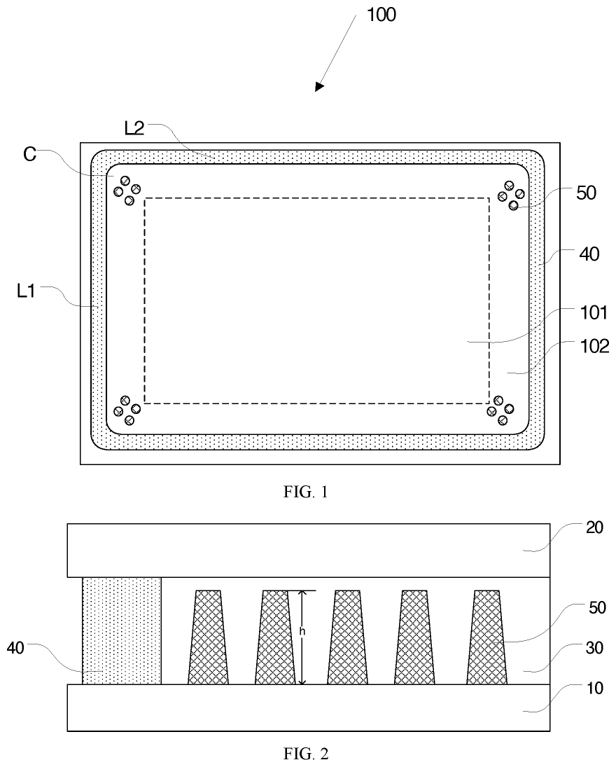

FIG. 2 is a cross-sectional structural diagram of a non-display area of the display panel provided in the first embodiment of the present invention.

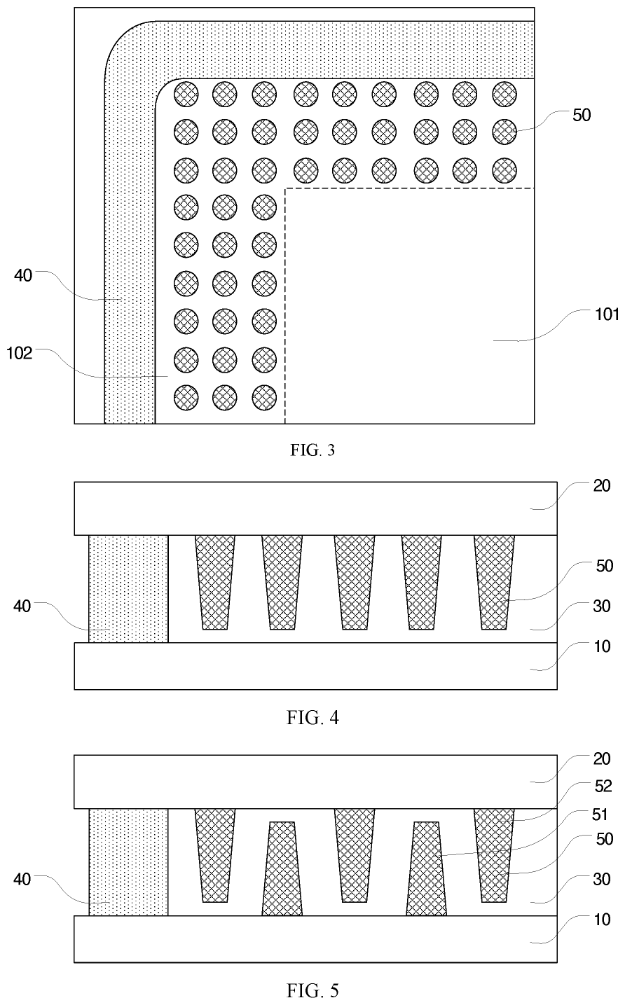

FIG. 3 is an enlarged view of a first corner of the display panel provided in the first embodiment of the present invention.

FIG. 4 is a cross-sectional structural diagram of the non-display area of the display panel provided in a second embodiment of the present invention.

FIG. 5 is a cross-sectional structural diagram of the non-display area of the display panel provided in a third embodiment of the present invention.

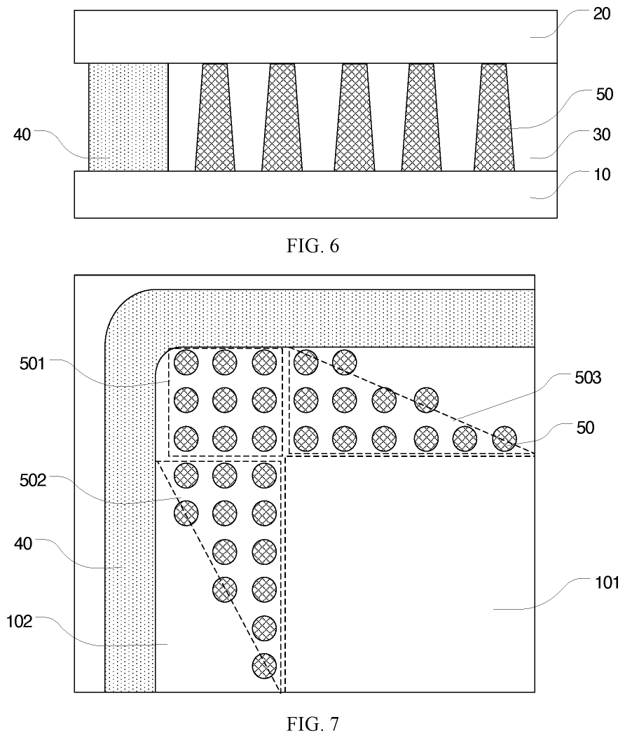

FIG. 6 is a cross-sectional structural diagram of the non-display area of the display panel provided in a fourth embodiment of the present invention.

FIG. 7 is an enlarged view of the first corner of the display panel provided in a fifth embodiment of the present invention.

Reference signs of the accompanying drawings:

| | |
|---|---|
| display panel 100 | display area 101 |
| non-display area 102 | binding area 121 |
| array substrate 10 | color film substrate 20 |
| liquid crystal layer 30 | sealant 40 |
| retaining wall 50 | first lateral side L1 |
| second lateral side L2 | first corner C |
| first retaining wall 51 | second retaining wall 52 |
| first area 501 | second area 501 |
| third area 503 | |

### EMBODIMENTS

### Detailed Description of Embodiments

The technical solutions in embodiments of the present invention will be clearly and completely described below in combination with the accompanying drawings in the embodiments of the present invention. In the description of the present invention, it should be understood that the terms indicated an orientation or positional relationship, for example, “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise” and the like, are based on an orientation or positional relationship shown in the accompanying drawings. It is only for convenience of describing the present invention and simplifying the description, and does not indicate or imply that a device or element referred to must have a specific orientation, be configured and operated in a specific orientation. Therefore, it cannot be understood as a limit of the present invention.

### First Embodiment

Please refer to FIG. 1 to FIG. 3, a display panel 100 provided in the embodiment has a display area 101 and a non-display area 102 surrounding the display area 101 and includes an array substrate 10, a color film substrate 20, a liquid crystal layer 30, a sealant 40, and a retaining wall 50.

The array substrate 10 and the color film substrate 20 are arranged opposite to each other and extend from the display area 101 to the non-display area 102. A structure of the color film substrate 20 includes, but is not limited to, a glass substrate, a spacer, a black matrix layer, a red resin layer, a green resin layer, or a blue resin layer. A structure of the array substrate 10 includes, but is not limited to, a glass substrate, a gate insulating layer, a passivation layer, or a pixel electrode layer.

The liquid crystal layer 30 is arranged between the array substrate 10 and the color film substrate 20, and extends from the display area 101 to the non-display area 102. The liquid crystal layer 30 includes a plurality of liquid crystals inside. According to the embodiment of the present invention, a specific material of the liquid crystal layer 30 is not particularly limited, and may include, but is not limited to, a polymer liquid crystal material, etc. In some embodiments of the present invention, the material of the liquid crystal layer 30 may be esters and biphenyl liquid crystal compounds. As a result, the materials are widely sourced, easily available, and low in cost.

The sealant 40 is arranged between the array substrate 10 and the color film substrate 20, and surrounds the liquid crystal layer 30. The sealant 40 is arranged in the non-display area 102, and the sealant 40 is used to seal the array substrate 10 and the color film substrate 20. A specific material of the sealant 40 is not particularly limited, for example, the sealant 40 may be XN-5A sealant 40. As a result, the materials are widely sourced, easily available, and low in cost. A width of the sealant 40 may ranges from 0.3 mm to 1.5 mm. In some specific embodiments of the present invention, the width of the sealant 40 may be 0.5 mm, 0.8 mm, 1.0 mm, 1.1 mm, 1.2 mm, 1.3 mm, 1.4 mm, or 1.5 mm. Thus, the wider the width of the sealant 40, the better a sealing effect.

In this embodiment, the sealant 40 is a closed shape, for example, the sealant 40 is square shaped, but this embodiment is not limited here, and the sealant 40 can be designed into polygonal according to different designs. The liquid crystal layer 30 is located in an accommodation space formed in the closed shape. The closed shape of the sealant 40 has a first lateral side L1, a second lateral side L2, and a first corner C. Wherein the first lateral side L1 is connected with the second lateral side L2, and the first corner C is formed at an intersection of the first lateral side L1 and the second lateral side L2. The sealant 40 is a quadrangular and has four corners. Since the sealant 40 surrounds the liquid crystal layer 30, the liquid crystal layer 30 also has four corners.

The retaining wall 50 is arranged in the liquid crystal layer 30 in the non-display area 102 and is located at the four corners of the liquid crystal layer 30. At each corner, a distribution area of the retaining wall 50 is L-shaped. The distribution area includes a transverse area and a longitudinal area extending perpendicular to each other, and each of the transverse area and the longitudinal area has a plurality of retaining walls arranged in an array. A length range of the distribution area of the retaining wall 50 in an extending direction of the first lateral side L1 is less than or equal to 20 mm. A length range of the distribution area of the retaining wall 50 in an extending direction of the second lateral side L2 is less than or equal to 20 mm.

A bottom portion of the retaining wall 50 abuts an inner surface of the array substrate 10, and a gap is provided between a top portion of the retaining wall 50 and the color film substrate 20.

In this embodiment, a material of the retaining wall 50 is organic, and specifically, the material of the retaining wall 50 is photosensitive resin. As a result, the materials are widely sourced, easily available, and low in cost.

Because the retaining wall 50 is organic and the liquid crystals are organic, there will be a molecular force between them. Existence of the retaining wall 50 will hinder flow of the liquid crystals. When the liquid crystals are difficult to flow, water vapor entered from an outside is also difficult to flow. The water vapor entered from the outside is blocked by the retaining wall 50, and it does not easily flow, which prolongs time to reach a GOA device, thus prolonging corrosion time of GOA and prolonging service life of the panel.

A number of the retaining walls 50 is at least one, but the molecular force between one of the retaining walls 50 and the liquid crystals is small, and a blocking effect of one of the retaining walls 50 on the flow of the liquid crystals is limited. Therefore, a plurality of retaining walls 50 can be set to improve the blocking effect. At least nine of the retaining walls 50 in three rows and three columns shall be provided at each corner.

The more retaining walls 50 are provided, the better the blocking effect of the water vapor will be. Therefore, at each corner of this embodiment, the retaining walls 50 are distributed in a rectangular shape as a whole, and the number of the retaining walls 50 is greater to ensure the blocking effect on the water vapor. An entire length of the retaining walls 50 is less than or equal to 20 mm.

In this embodiment, an axial cross-sectional shape of the retaining walls 50 is trapezoidal. In other embodiments, the axial cross-sectional shape of the retaining walls 50 may be triangular or rectangular, which is not limited here.

A distance between the retaining walls 50 may range from 20 um to 100 um. In some specific embodiments, the distance between the retaining walls 50 may be 20 um, 30 um, 40 um, 50 um, 70 um, 90 um, or 100 um. The smaller the distance between the retaining walls 50, the stronger the molecular force of the water vapor, and the better the blocking effect on the water vapor.

A height direction of the retaining walls 50 is a thickness direction of the display panel 100, and a height h of the retaining walls 50 may range from 1 um to 10 um. In some specific embodiments of the present invention, the height h of the retaining walls 50 may be 2 um, 3 um, 4 um, 5 um, 7 um, 9 um, or 10 um.

A diameter of the bottom portion of the retaining walls 50 may range from 5 um to 50 um, and a diameter of the top portion of the retaining walls 50 may range from 5 um to 50 um. In some specific embodiments of the present invention, the diameter of the bottom portion of the retaining walls 50 may be 10 um, 30 um, 40 um, or 50 um, and the diameter of the top portion of the retaining walls 50 may be 10 um, 30 um, 40 um, or 50 um.

According to the embodiment of the present invention, the specific shape of the retaining walls 50 is not particularly limited. The retaining walls 50 may be a regular retaining wall 50 integrally designed, for example, vertical retaining walls 50 or retaining walls 50 having a slope on at least one side. They can also be spliced by a plurality of structures, for example, one part of the retaining walls 50 and another part of the retaining walls 50 are butted.

A display device is further provided in the present invention. According to embodiments of the present invention, the display device includes the above-mentioned display panel 100. The display device has a strong stability, good picture quality, and high display quality, and has all the features and advantages of the display panel 100 described above, and will not be described here.

According to the embodiment of the present invention, a shape, a structure, a manufacturing process, etc. of the display device are not particularly limited. As long as requirements are met, those skilled in the art can flexibly select according to needs. Those skilled in the art can understand that, in addition to the display panel 100 described above, the display device has a structure of a conventional display device, for example, it can also include organic light-emitting diode (OLED) light emitting devices and the like, which will not be described here.

According to the embodiments of the present invention, a specific type of the display device is not particularly limited, for example, it includes, but is not limited to, a liquid crystal display (LCD) display panel 100, an OLED display panel 100, a mobile phone, a tablet computer, a wearable device, a game machine, etc.

### Second Embodiment

A structure of the display panel 100 of this embodiment is similar to the structure of the display panel 100 of the first embodiment. Please refer to the description of the first embodiment for the specific structure. A difference between the structure of the first embodiment and the structure of the first embodiment is that the top portion of the retaining wall 50 of this embodiment abuts an inner surface of the color film substrate 20, and a gap is provided between the bottom portion of the retaining wall 50 and the array substrate 10. The cross-sectional shape of the retaining wall 50 is an inverted trapezoid. Please refer to FIG. 4 for details.

### Third Embodiment

A structure of the display panel 100 of this embodiment is similar to the structure of the display panel 100 of the first embodiment. Please refer to the description of the first embodiment for the specific structure. A difference between the structure of the first embodiment and the structure of the first embodiment is that the retaining wall 50 in this embodiment includes a first retaining wall 51 and a second retaining wall 52. A bottom portion of the first retaining wall 51 abuts the inner surface of the array substrate 10, and a gap is provided between a top portion of the first retaining wall 51 and the color film substrate 20. A top portion of the second retaining wall 52 abuts an inner surface of the color film substrate 20, and a gap is provided between a bottom portion of the second retaining wall 52 and the array substrate 10. The first retaining wall 51 and the second retaining wall 52 are staggered. Please refer to FIG. 5 for details.

### Fourth Embodiments

A structure of the display panel 100 of this embodiment is similar to the structure of the display panel 100 of the first embodiment. Please refer to the description of the first embodiment for the specific structure. A difference between the structure of the first embodiment and the structure of the first embodiment is that the top portion of the retaining wall 50 in this embodiment abuts an inner surface of the color film substrate 20, and the bottom portion of the retaining wall 50 abuts the inner surface of the array substrate 10. Please refer to FIG. 6 for details.

The retaining wall 50 forms a supporting column that bonds upper and lower substrates. When the display panel 100 is bent under a force, a structure of the supporting column will prevent invagination between the array substrate 10 and the color film substrate 20. Meanwhile, due to blocking of the retaining wall 50, the liquid crystals cannot flow to both sides of the retaining wall 50, thereby ensuring consistency of a cell thickness of the display panel 100 in a bending area.

### Fifth Embodiment

A structure of the display panel 100 of this embodiment is similar to the structure of the display panel 100 of the first embodiment. Please refer to the description of the first embodiment for the specific structure. A difference between the structure of the first embodiment and the structure of the first embodiment is that, at each corner, the distribution area of the retaining wall 50 includes a first area 501 located at the corner, and a second area 502 and a third area 503 connected with adjacent two sides of the first area 501, respectively. A shape of the first area 501 is square, and shapes of the second area 502 and the third area 503 are triangular, please refer to FIG. 7. In other embodiments, the shapes of the second area 502 and the third area 503 can be trapezoidal.

In the embodiment, a greater number of the retaining walls 50 is provided, and the blocking effect on the water vapor will be better. However, there is a great compressive stress in a corner area, which will cause the substrate at the corner to be pushed open, resulting in peeling problems. In addition, if the number of the retaining walls 50 is too great, fluidity of the liquid crystals will also be affected, resulting in a corner bubble problem. Therefore, at each corner of this embodiment, the retaining walls 50 are distributed in a triangular shape as a whole, and the number of the retaining walls 50 is moderate to ensure reliability on the premise of ensuring water resistance.

A display panel provided by the embodiments of the present invention has been described in detail above. In this paper, specific examples have been applied to explain a principle and an implementation mode of the present invention. The description of the above-mentioned embodiments is only used to help understand a technical scheme and a core idea of the present invention. Those skilled in the art should understand that it is still possible to modify the technical solutions described in the foregoing embodiments, or to equivalently replace some of the technical features. These modifications or substitutions do not make essence of the corresponding technical solutions depart from a scope of the technical solutions of the embodiments of the present invention.

1. A display panel, having a display area and a non-display area surrounding the display area, and comprising:
an array substrate and a color film substrate arranged opposite to each other and both extending from the display area to the non-display area;
a liquid crystal layer arranged between the array substrate and the color film substrate and extending from the display area to the non-display area;
a sealant arranged between the array substrate and the color film substrate and surrounding the liquid crystal layer, and the sealant located in the non-display area; and
a retaining wall arranged in the liquid crystal layer in the non-display area.

2. The display panel as claimed in claim 1, wherein a bottom portion of the retaining wall abuts the array substrate, and a gap is provided between a top portion of the retaining wall and the color film substrate.

3. The display panel as claimed in claim 1, wherein a top portion of the retaining wall abuts the color film substrate, and a gap is provided between a bottom portion of the retaining wall and the array substrate.

4. The display panel as claimed in claim 1, wherein the retaining wall comprises a first retaining wall and a second retaining wall, a bottom portion of the first retaining wall abuts the array substrate, and a gap is provided between a top portion of the first retaining wall and the color film substrate; a top portion of the second retaining wall abuts the color film substrate, and a gap is provided between a bottom portion of the second retaining wall and the array substrate; and the first retaining wall and the second retaining wall are staggered.

5. The display panel as claimed in claim 1, wherein a bottom portion of the retaining wall abuts the array substrate, and a top portion of the retaining wall abuts the color film substrate.

6. The display panel as claimed in claim 1, wherein an axial cross-sectional shape of the retaining wall is triangular, trapezoidal, rectangular, or inverted trapezoidal.

7. The display panel as claimed in claim 1, wherein a number of the retaining walls is 2 or more, and a distance between the retaining walls ranges from 20 um to 100 um.

8. The display panel as claimed in claim 1, wherein a height of the retaining wall ranges from 1 um to 10 um, and a diameter of a bottom portion of the retaining wall ranges from 5 um to 50 um.

9. The display panel as claimed in claim 1, wherein a width of the sealant ranges from 0.3 mm to 1.5 mm.

10. The display panel as claimed in claim 1, wherein a material of the retaining wall is acrylic copolymer.

11. The display panel as claimed in claim 1, wherein a material of the retaining wall is photosensitive resin.

12. The display panel as claimed in claim 1, wherein the sealant seals the array substrate and the color film substrate.

13. The display panel as claimed in claim 1, wherein the retaining wall is arranged at four corners of the liquid crystal layer, and at each of the corners, a distribution area of the retaining wall is L-shaped; the distribution area comprises a transverse area and a longitudinal area extending perpendicular to each other, and each of the transverse area and the longitudinal area has a plurality of the retaining walls arranged in an array.

14. The display panel as claimed in claim 1, wherein the retaining wall is arranged at four corners of the liquid crystal layer, at each of the corners, a distribution area of the retaining wall comprises a first area located at the corner, and a second area and a third area connected with adjacent two sides of the first area, respectively; a shape of the first area is a square, and shapes of the second area and the third area are both trapezoidal or triangular.

15. A display device, comprising a display panel, having a display area and a non-display area surrounding the display area, and comprising:
an array substrate and a color film substrate arranged opposite to each other and both extending from the display area to the non-display area;
a liquid crystal layer arranged between the array substrate and the color film substrate and extending from the display area to the non-display area;
a sealant arranged between the array substrate and the color film substrate and surrounding the liquid crystal layer, and the sealant located in the non-display area; and
a retaining wall arranged in the liquid crystal layer in the non-display area.

16. The display device as claimed in claim 15, wherein a bottom portion of the retaining wall abuts the array substrate, and a gap is provided between a top portion of the retaining wall and the color film substrate.

17. The display device as claimed in claim 15, wherein a top portion of the retaining wall abuts the color film substrate, and a gap is provided between a bottom portion of the retaining wall and the array substrate.

18. The display device as claimed in claim 15, wherein the retaining wall comprises a first retaining wall and a second retaining wall, a bottom portion of the first retaining wall abuts the array substrate, and a gap is provided between a top portion of the first retaining wall and the color film substrate; a top portion of the second retaining wall abuts the color film substrate, and a gap is provided between a bottom portion of the second retaining wall and the array substrate; and the first retaining wall and the second retaining wall are staggered.

19. The display device as claimed in claim 15, wherein a bottom portion of the retaining wall abuts the array substrate, and a top portion of the retaining wall abuts the color film substrate.

20. The display device as claimed in claim 15, wherein an axial cross-sectional shape of the retaining wall is triangular, trapezoidal, rectangular, or inverted trapezoidal.
